(19) United States
(12) Patent Application Publication
(10) Pub. No.: US 2006/0128847 A1
(43) Pub. Date: Jun. 15, 2006

(54) Method of retaining the hydrolytic stability of flame retarded polymer composition

(76) Inventors: Sergei Levchik, Croton-on-Hudson, NY (US); Gerald R. Alessioi, Emerson, NJ (US); Danielle A. Bright, New City, NY (US)

Correspondence Address: DILWORTH & BARRESE, LLP, 333 EARLE OVINGTON BLVD., UNIONDALE, NY, 11553, US

(21) Appl. No.: 10/533,249

(22) PCT Filed: Oct. 28, 2003
(86) PCT No.: PCT/US03/34351

§ 371 Date: Nov. 14, 2005

Related U.S. Application Data
(60) Provisional application No. 60/422,682, filed on Oct. 31, 2002.

(51) Int. Cl. C08K 5/49

(52) U.S. Cl. 524/117

(57) ABSTRACT

The hydrolytic stability of a polycarbonate-containing resin composition, which comprises an arylene-bridged oligomeric phosphate flame retardant can be improved by the addition of an effective amount of a neopentylglycol bis(diphenyl phosphate) flame retardant for such hydrolytic stability improvement.

### FIELD OF THE INVENTION

This invention relates to improving the physical properties of fire retardant polycarbonate resin compositions, more particularly, aromatic polycarbonate and acrylonitrile-butadiene-styrene copolymer blends, when they are exposed to humid atmospheric conditions over time.

### BACKGROUND OF THE INVENTION

It is desirable for polycarbonate blend compositions to have a good balance of physical properties, such as tensile strength, stiffness, compressive and shear strength, and impact resistance. These compositions are used in electric and electronic products, such as computer monitor and copy machine housings, where the composition is exposed to elevated temperatures for extended time periods. Humidity in the atmosphere may also be high for extended periods of time depending on the geographic location. If the composition cannot retain such desirable physical properties as mechanical strength during such exposure to humid conditions, the lifetime of the product will be shortened because of degradation of those physical properties.

Therefore, in addition to absolute physical properties, such as tensile strength, impact resistance and flame retardance, it is also desirable to have any such compositions also possess good long-term heat and hydrolytic stability. This long-term stability is a relative value that is measured over a certain defined time period under the conditions that would normally degrade such desired characteristics. More specifically, such degradation is manifested as a loss of molecular weight of the polycarbonate resin upon exposure to high heat and high humidity over time. Accelerated test procedures, which can be performed during a reasonable period of time in the laboratory, allow for an estimation of the anticipated long-term stability in actual service of such flame retarded polycarbonate molding compositions, which are employed, for example, as housing materials for home appliances, office machines, and computers.

Aromatic bisphosphate compounds have such desired characteristics as low volatility, high temperature stability, and a low tendency to exude from the polymer, so that they are quite desirable for use as a flame retardant or plasticizer for imparting fire retardancy, temperature stability, and good moldability to thermoplastic or thermosetting resins. Also, aromatic bisphosphates show resistance to high temperature up to about 300° C., which is a temperature that is needed for the processing of some engineering plastics.

The use aromatic bisphosphates and a tetrafluoroethylene polymer to confer flame retardancy on polycarbonate/ABS resin compositions is described in a number of patent documents including the following: U.S. Pat. Nos. 4,172,858; 4,248,976; 5,013,776; 5,036,126; 5,045,582; 5,157,065; 5,204,394; 5,219,907; 5,234,980; 5,272,193; 5,292,786; 5,455,292; 5,618,867; 5,733,957; 5,741,838; 5,837,757; 5,864,004; 5,871,570; 5,994,433; 6,083,428; Re. 36,188 and Re. 36,902; British Patent Nos. 2,325,933 and 2,332,203; German Patent Applications Nos. 198,53,108; 199,14,137; 199,14,139; French Patent Application No. 2,781,807; European Patent Applications Nos. 816,434; 933,396; 936,243 and 1,069,156 and PCT International Patent Publications Nos. 98/53002; 99/43747; 99/57198 and 99/61523. However, the long-term heat and hydrolytic stability of PC/ABS compositions that have been flame retarded with such aromatic bisphosphates is not always satisfactory.

U.S. Pat. No. 5,952,408 describes the use of a low concentration of a zeolite to improve the tensile strength upon the aging of PC/ABS resin that has been flame retarded by the addition of resorcinol bis(diphenyl phosphate). German Patent Publication No. 198,56,484 shows the use of a small amount of highly dispersed silica for improving the Vicat temperature, elongation and Izod strength of PC/ABS containing resorcinol bis(diphenyl phosphate). Inorganic oxides of a selected group of metals (e.g., Mg, Ca, Ba, Sr, Al, and Zn) have also been shown in to provide a stabilizing effect PC/ABS added by aromatic phosphates (European Patent Publication No. 936,244).

The addition of epoxide-type acid scavengers in order to improve the hydrolytic stability of PC/ABS has been described in European Patent Publication No. 909,790 and U.S. Pat. No. 5,871,570 with the action of such epoxy compounds being presumed to result in the deactivation of phosphoric acid and phenolic-type species that may appear at processing thereby causing the thermal or hydrolytic decomposition of the aromatic bisphosphate. These species decrease molecular weight of the mostly polycarbonate polymer composition and deteriorate its physical properties. The problem with this type of stabilization is that such epoxides form aliphatic esters or ethers with phosphoric acid and phenolic species, respectively, which, in turn, are also unstable and undergo thermal decomposition and hydrolysis upon aging.

### SUMMARY OF THE INVENTION

The present invention relates to the improvement in the resistance against degradation under conditions of high temperature and high humidity of the foregoing type of resin composition by incorporation therein of a combination of an oligomeric arylphosphate and neopentylglycol bis(diphenyl phosphate).

The resin composition to which the foregoing blend of phosphate flame retardants can be added is a blend comprising polycarbonate resin (PC) and acrylonitrile-butadiene-styrene (ABS) resin and, preferably, an antidriping agent.

While PCT Patent Publication WO 96/11977 teaches the incorporation of neopentylglycol bis(diphenyl phosphate) into PC/ABS resin compositions along with certain oligomeric arylphosphate flame retardants of the type described herein, it only addresses the flame retardant and melt flow characteristics of the resulting compositions without any showing or suggestion of retention of the hydrolytic stability of such compositions over time.

### DETAILED DESCRIPTION OF THE INVENTION

The polycarbonate resin component, (a), that used in the compositions that are improved by the present invention is a thermoplastic resin obtained by reacting a diphenolic compound with a carbonic acid diester, such as phosgene or diphenyl carbonate. It exhibits desirable impact resistance, heat distortion resistance, and mechanical strength. A typical example of such a polycarbonate resin is a resin obtained by reacting bisphenol A with diphenyl carbonate. The molecular weight of the polycarbonate is not particularly limited, but from the point of view of good mechanical strength and processability, it is preferable to have the viscosity average molecular weight of the composition within the range of from about 10,000 to about 40,000.

Another ingredient for such a resin composition is a graft copolymer resin (b) made according to the known process by copolymerizing one or more monomers selected to provide a rigid polymeric superstrate in the presence of particles of a rubbery polymeric substrate under conditions such that at least a portion of the rigid polymeric superstrate is chemically grafted to the rubbery polymeric substrate. The preferred graft copolymer resins include, for example, acrylonitrile-butadiene-styrene resins commonly referred to as ABS resins. Preferred are high rubber graft ABS having at least 30 wt. %, preferably about 45 wt. % of rubbery polymeric substrate.

The oligomeric arylphosphates (c) heretofore used in such resin compositions are represented by formula (1): 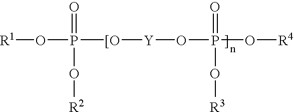
where R¹, R², R³, R⁴=aryl, and Y is arylene “n” is equal to or greater than 1.2. They are particularly preferred from the point of view of excellent flame retardancy, good compatibility with the resin. Moreover, they are easy to handle. Typical examples of oligomeric arylphosphates are resorcinol bis(diphenyl phosphate) (“RDP”) and bisphenol A bis(diphenyl phosphate) (“BDP”) which are available from Akzo Nobel Chemicals under the trademark name of FYROLFLEX.

The present invention specifically relates to the additional presence, with the aforementioned type of flame retardant, of neopentylglycol bis(diphenyl phosphate) (“NDP”) (d) of the following formula (2): 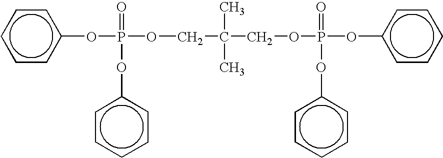
This additional flame retardant additive can be prepared as described in the U.S. Pat. No. 6,136,997. Preferably, it is a liquid product containing more than 80 wt. % of the bisphosphate (formula 2), less than 5 wt. % of the cyclic product 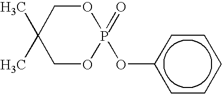
and less than 8 wt. % of triphenyl phosphate.

The total amount of phosphate flame retardant in the resin composition can range from about 5% to about 40%, by weight of the composition, with the weight ratio of arylene-bridged species to NDP ranging from about 9:1 to about 1:9.

The composition of this invention preferably also preferably includes an anti-dripping agent (e) which is a fluoropolymer, preferably poly(tetrafluoroethylene) (PTFE). In a highly preferred embodiment, the PTFE particles range in size from 50 to 500 nm.

The present invention is further illustrated by reference to the Examples that follow.

### EXAMPLE 1

Bisphenol A bis(diphenyl phosphate) and neopentylglycol bis(diphenyl phosphate) were mixed at different ratios as shown in Table 1.

TABLE 1

| | Aromatic |
|---|---|
| # | bisphosphate |
| 1 | BDP |
| 2 | NDP |
| 3 | BDP/NDP = 4:1 |
| 4 | BDP/NDP = 3:2 |
| 5 | BDP/NDP = 2:3 |
| 6 | BDP/NDP = 1:4 |

BDP: Bisphenol A bis(diphenyl phosphate)
NDP: Neopentylglycol bis(diphenyl phosphate)

### EXAMPLES 7-13

Pellets of polycarbonate resin (PC) and ABS resin were blended at the ratio 4:1. Then, 0.3 wt. % of poly(tetrafluoroethylene) (PTFE) was added to the blend. Resorcinol bis(diphenyl phosphate) (RDP), BDP, NDP and mixtures of BDP and NDP, as prepared in Example 1, were then compounded into the PC/ABS resin at a level insuring a 1.1 wt. % phosphorus content in the formulation.

The polymer compositions were prepared on a twin-screw extruder and were shaped into the test specimens on a 50 ton injection molding machine. The flame retardant performance of the formulations was evaluated according to the UL-94 vertical test protocol using standard bars of 1.6 and 3.2 mm thickness. Izod impact strength was measured on a TMI 43-02 apparatus according to the ASTM D256 standard using notched samples. Tensile strength was measured using an INSTRON 4505 apparatus according to the ASTM D638 standard. Heat deflection temperature (HDT) was measured with samples of 3.2 mm thickness at 1.82 MPa using a Tinius Olsen apparatus according to the ASTM D648 standard. Melt Flow Index (MFI) was measured on Tinus Olster Plastometer according to AST D1238.

Aging tests were performed on pellets of flame retardant formulations in the sealed 50 ml test-tubes at 107° C. and 100% humidity. The molecular weight of the PC resin was monitored by GPC as described in European Patent Publication No. 936,243. The retention of molecular weight was determined as the per cent ratio of M. of the aged formulation to the M; of the original formulation. Table 2, which follows, sets forth the results.

TABLE 2

| | | Physical properties | | | UL94 | | | |
|---|---|---|---|---|---|---|---|---|
| | Aromatic | Izod, | | Tens, str., | 1.6 | 3.2 | MFI | Retain |
| # | Bisphosphate | ft-lb/in | HDT° C. | psi | mm | mm | min/10 g | Mw, % |
| 7 | RDP | 7.4 ± 0.5 | 81.8 ± 0.8 | 6800 ± 200 | V-0 | V-0 | 21.5 ± 0.1 | 14 |
| 8 | BDP | 6.5 ± 0.6 | 85.2 ± 0.6 | 6900 ± 200 | V-0 | V-0 | 23.1 ± 0.3 | 43 |
| 9 | BDP/NDP = 4:1 | 7.2 ± 1.6 | 85.5 ± 0.8 | 6730 ± 60 | V-0 | V-0 | 22.3 ± 0.3 | 53 |
| 10 | BDP/NDP = 3:2 | 6.1 ± 1.2 | 82.3 ± 0.5 | 6800 ± 600 | V-0 | V-1 | 21.4 ± 0.3 | 56 |
| 11 | BDP/NDP = 2:3 | 6.5 ± 0.7 | 82.0 ± 0.6 | 6580 ± 80 | V-1 | Fail | 21.7 ± 0.2 | 58 |
| 12 | BDP/NDP = 1:4 | 8.2 ± 0.9 | 83 ± 1 | 7200 ± 200 | V-1 | Fail | 21.2 ± 0.2 | 60 |
| 13 | NDP | 8.1 ± 0.6 | 82.5 ± 0.2 | 7400 ± 200 | V-1 | Fail | 19.1 ± 0.3 | 70 |

RDP—resorcinol bis(diphenyl phosphate)
BDP bisphenol A bis(diphenyl phosphate)
NDP—neopentylglycol bis(diphenyl phosphate)

After aging, formulation 7 containing RDP retained 14% of its original molecular weight, but formulation 8 containing BDP retained 43% of its molecular weight. With increasing content of NDP in BDP/NDP mixtures 9 to 12, the retained molecular weight increased which is an indication of improved hydrolytic stability for the composition.

An increase in the NDP content in the BDP/NDP mixtures led to a decrease of MFI without a loss of such physical properties as measured by Izod strength, HDT and tensile strength, which is beneficial for high productivity injection molding.

1. A method of improving the hydrolytic stability of a polycarbonate-containing resin composition comprising the placing under humid conditions, for a sufficient period of time, of such a resin composition comprising the polycarbonate resin and a flame retardant blend comprising an arylene-bridged oligomeric phosphate composition and an effective amount of neopentylglycol bis(disphenyl phosphate) so that the hydrolytic stability of the resin composition under such conditions is retained to a greater degree as compared to a composition comprising, as a flame retardant therein, a composition comprising the arylene-bridged oligomeric phosphate composition without the neopentylglycol bis (diphenylphosphate).

2. A method as claimed in claim 1 wherein the arylene-bridged oligmeric phosphate composition contains a bridging group derived from bisphenol A.

3. A method as claimed in claimed in claim 1 wherein the total amount of phosphate ester flame retardant in the composition ranges from about 5% to about 40%, by weight of the composition.

4. A method as claimed in claim 1 wherein the ratio of arylene-bridged oligomeric phosphate composition to neopentylglycol bis(diphenyl phosphate) ranges from about 9:1 to about 1:9.

5. A method as claimed in claim 2 wherein the total amount of phosphate ester flame retardant in the composition ranges from about 5% to about 40%, by weight of the composition.

6. A method as claimed in claim 5 wherein the ratio of arylene-bridged oligomeric phosphate composition to neopentylglycol bis(diphenyl phosphate) ranges from about 9:1 to about 1:9.

7. A method as claimed in claim 2 wherein the ratio of arylene-bridged oligomeric phosphate composition to neopentylglycol bis(diphenyl phosphate) ranges from about 9:1 to about 1:9.

8. A method as claimed in claim 3 wherein the ratio of arylene-bridged oligomeric phosphate composition to neopentylglycol bis(diphenyl phosphate) ranges from about 9:1 to about 1:9.
